(19) United States
(12) Patent Application Publication
(10) Pub. No.: US 2018/0095157 A1
(43) Pub. Date: Apr. 5, 2018

(54) Determining The Position Of A Vehicle

(71) Applicant: SIEMENS AKTIENGESELLSCHAFT, MUENCHEN (DE)

(72) Inventor: Steffen SCHAEFER, MUENCHEN (DE)

(21) Appl. No.: 15/561,616

(22) PCT Filed: Mar. 22, 2016
(86) PCT No.: PCT/EP2016/056234

§ 371 Date: Sep. 26, 2017

(30) Foreign Application Priority Data
Mar. 26, 2015 (DE) 102015205535.3

(51) Int. Cl. G01S 5/02; G01S 1/08; G01S 19/01; G01C 21/16

(52) U.S. Cl. CPC G01S 5/0252; G01S 1/08; B61L 2205/04; G01C 21/16; B61L 2205/02; G01S 19/01

(57) ABSTRACT

A sensor device for a vehicle that traveling on a predetermined route, particularly a rail vehicle, includes a plurality of sensors configured to detect movement of the sensor device and/or physical variables of an environment of the sensor device, and to issue corresponding measurement values. The sensors include magnetic sensors for detecting orientation and/or pressure sensors and/or real time clocks. A data storage unit is configured to store reference measurement values for the sensors, relating to predetermined positions on the predetermined route. A computing unit is configured to compare the measurement values issued by the sensors with the stored reference measurement values and, when the measurement values issued by the sensors coincide with the reference measurement values, to issue, as a current position of the sensor device, a position corresponding to the respective reference measurement values. A corresponding vehicle and a corresponding method are also provided.

The invention relates to a sensor device for determining the position of a vehicle that travels on a predetermined route, in particular a rail vehicle. The invention also relates to a vehicle, a use and a method.

Although hereinafter the present invention is mainly described with reference to rail vehicles, it can be used with any type of vehicles that travel on predetermined routes.

In modern mass transit systems, such as subways, streetcars and trains, it is frequently difficult to determine the position of the respective vehicle exactly.

Typically, for example, GPS receivers are used, which can be combined with further sensors. For example, radio beacons can be installed along a railroad line. To keep the costs of the installation of radio beacons low, however, large distances between beacons are selected in order to keep the number of beacons low. However, this results in less precise position determination with the beacons. The same applies to triangulation based on mobile radio signals.

Moreover, trains, in particular high-speed trains, travel at speeds that are so high that exact position determination using GPS or triangulation is not possible. Moreover, radio signals, emitted, for example, by stationary radio beacons, can be blocked by obstacles and tunnels. The same applies, for example, to subway trains, which almost exclusively travel underground.

Frequently, passengers in trains or subways have smartphones or the like, for example, with GPS receivers that can be used for position determination. However, these are subject to the same restrictions as described above for GPS sensors in the actual vehicles.

DE 195 32 104 C1 discloses a device for determining the position of a track-guided vehicle. DE 101 04 946 A1 discloses a method for determining and monitoring the planned position of an object. DE 10 2013 013 156 A1 discloses a method with which an additional transmitter is integrated in a navigation system.

It is the object of the present invention to provide improved position detection for vehicles.

This object is achieved by a sensor device as claimed in claim 1, a vehicle as claimed in claim 10, a use as claimed in claim 11 and a method as claimed in claim 12.

According to the invention, the sensor device comprises a number—i.e. one or more—sensors designed to detect a movement of the sensor device and/or physical variables of an environment of the sensor device and to issue corresponding measurement values. Herein, the sensors can detect the movement directly or indirectly. This means that the sensors can, for example, supply position information directly or the position can be derived from the sensor values for example by integration or differentiation. The physical variables detected can, for example, be all variables enabling a position to be recognized. The sensors comprise at least magnetic field sensors for detecting an orientation and/or pressure sensors and/or real-time clocks.

Moreover, the sensor device comprises a data storage unit designed to store reference measurement values for the sensors relating to predetermined positions on the predetermined route. To this end, the predetermined positions can be defined on the predetermined route for example at intervals corresponding to the desired spatial resolution. Consequently, the string of predetermined positions identifies the predetermined route. The corresponding reference measurement values relating to each of the predetermined positions can be stored in the data storage unit and be used for comparison with the measurement values detected by the sensors.

To this end, the sensor device comprises a computing unit that is coupled to the sensors and compares the measurement values issued by the sensors with the stored reference measurement values. When the measurement values issued by the sensors coincide with the reference measurement values, the computing unit issues the position corresponding to the respective reference measurement values as the current position of the sensor device or the vehicle.

To compare measurement values issued by the sensors with the reference measurement values, it is possible to define intervals or maximum deviations. If the measurement values issued by the sensors lie within the respective interval or maximum deviation for one of the reference measurement values, the comparison can be considered to be positive or as accurate and/or it is assumed that the values coincide.

For position determination, the invention uses reference measurement values identifying, for example, local circumstances of the respective positions. Moreover, the invention utilizes the knowledge that such local circumstances are typically different for each position on a predetermined route.

Moreover, these local circumstances can be very simply detected by sensors installed locally in the sensor device.

Consequently, a simple comparison of the detected measurement values with the reference measurement values stored for the individual positions is sufficient to determine the current position of the vehicle from the plurality of stored positions.

Consequently, the present invention enables the determination of the position of a vehicle on a predetermined route with very simple means and is not reliant on external signals.

Further, particularly advantageous embodiments and developments of the invention are derived from the dependent claims and the following description, wherein the independent claims of one claim category can also be developed analogously to the dependent claims of another claim category and the features of different exemplary embodiments can be combined to form new exemplary embodiments.

In order, for example, to notify passengers on the vehicle of the current position, the sensor device can comprise a wireless communication interface. For example, a Bluetooth interface, a WLAN interface, a GSM interface or the like can be provided. When a GSM interface or any other interface with a corresponding range is used the current position can, moreover, be routed for example to a control station or control center. When passengers know the exact position, for example, of the train in which they are located, they can, for example, retrieve information on sights of interest in the environment of the current position using a smartphone. Moreover, passengers, for example on the subway, can be shown the exact position of their train or the train for which they are waiting. Moreover, knowledge of the train in which a passenger is located enables the passenger for example to be shown detailed information on the current timetable, delays to the train and the like. In order to determine the position of the vehicle or the sensor device exactly, the sensors can comprise acceleration sensors and/or rotational speed sensors.

Moreover, the computing unit can be designed to detect a movement of the sensor device based on the measurement values issued by the acceleration sensors and/or rotational speed sensors. In addition to a comparison of the detected measurement values, this for example also enables inertial navigation or dead reckoning. In addition to the comparison of the measurement values with the reference measurement values, this enables a movement of the vehicle to be calculated exactly and compared with the stored predetermined positions.

In addition to the aforementioned sensors, further possible sensors include, for example, satellite-based position sensors, a microphone or the like. As mentioned, a magnetic field sensor, for example a compass, can determine an orientation of the vehicle. A pressure sensor can determine the height of the vehicle and a satellite-based position sensor, for example a GPS sensor, can determine an approximate position of the vehicle.

In particular with the use of a satellite-based position sensor, the imprecisely determined position of the vehicle determined thereby can be used to restrict the sets of reference measurements in question for the comparison by the computing unit. For example, the comparison can be restricted to the sets of reference measurement values relating to positions in a predetermined circle around the imprecisely determined position. This enables the computing load of the computing unit to be reduced.

In one embodiment, the data storage unit can comprise reference measurement values for a plurality of predetermined routes. In one such embodiment, the computing unit can be designed to determine, based on the measurement values issued by the sensors, on which of the predetermined routes the vehicle is moving. For example, the data storage unit can hold resident reference measurement values for a plurality of subway lines that may intersect, run partially parallel next to one another or one above the other or the like. The computing unit can, for example, store the detected measurement values for a predetermined period and, based on a temporal projection or temporal consideration of the measurement values and the reference measurement values, determine not only the current position but also the respective route from the plurality of routes.

To facilitate communication to, for example, smartphones owned by passengers in the vehicle, the sensor device can comprise at least three wireless communication interfaces, which can, for example, be designed as Bluetooth interfaces. If three wireless communication interfaces are provided, these can be used as so-called “iBeacons”, thus enabling particularly simple communication of the current position. To this end, the computing unit can, for example, issue, via each of the wireless communication interfaces, a predetermined unique identification common to the communication interfaces and a unique primary identifier and a unique secondary identifier for each current position. Herein, each combination of a unique primary identifier and a unique secondary identifier in each case identifies a position on the route.

The sensor device can also be used in vehicles traveling along a route for which no reference measurement values in the data storage unit are held resident as yet. To this end, the computing unit can, for example, during a reference journey on the predetermined route, store the measurement values issued by the sensors in the data storage unit as the reference measurement values together with the respective current position of the sensor device. This makes it possible to record the reference measurement values for any route desired.

In order to be able to link the reference measurement values detected thereby with a position on the route, the computing unit can be designed to request the respective current position from a reference sensor. To this end, it is, for example, possible to use a user-calibrated satellite-based sensor, for example a high-precision GPS sensor. It is also possible to use any other type of high-precision position determination. Complex high-precision measuring apparatus can be removed again from the vehicle after the reference journey and used again in other applications.

The invention is described again in more detail below with reference to the attached figures and the exemplary embodiments. Herein, the same components are given identical reference numbers in the different figures, which show:

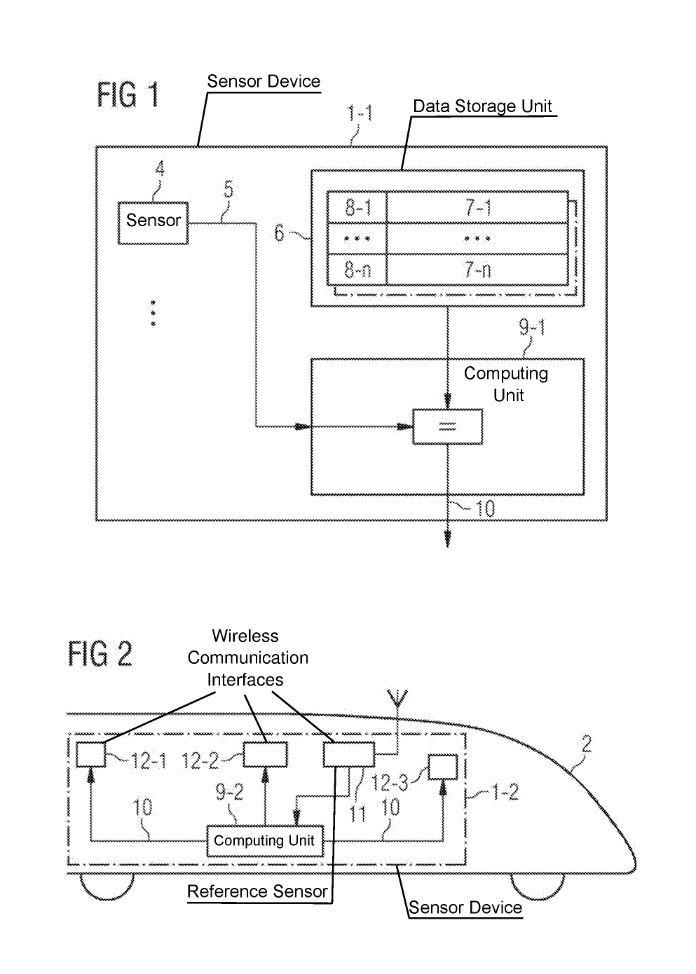

FIG. 1 a block diagram of an embodiment of a sensor device according to the invention,

FIG. 2 a depiction of an embodiment of a vehicle according to the invention,

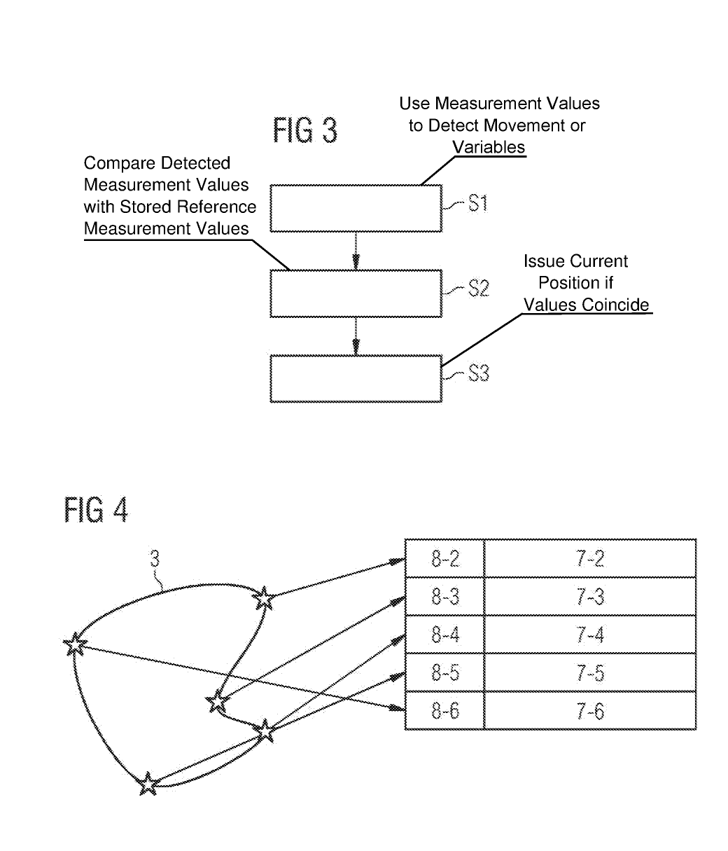

FIG. 3 a flow chart of an embodiment of a method according to the invention,

FIG. 4 a depiction of a route and the corresponding reference measurement values.

FIG. 1 shows a sensor device 1-1 comprising a sensor 4. Further possible sensors are indicated by three dots.

The sensor 4 supplies measurement values 5 relating to a movement of the sensor device 1-1 or to physical variables of an environment of the sensor device 1-1 to the computing unit 9-1.

The computing unit 9-1 is coupled to a data storage unit 6 comprising in each case reference measurement values 7-1 to 7-n relating to predetermined positions 8-1 to 8-n on a route 3, which are depicted in tabular form in FIG. 1. Herein, the number of reference measurement values 7-1 to 7-n or predetermined positions 8-1 to 8-n on the route 3 is determined in one embodiment from the length of the route and the desired spatial resolution. Herein, the distance between the individual positions 8-1 to 8-n corresponds at maximum to the desired spatial resolution.

A comparison of the measurement values 5 detected by the sensor 4 with the reference measurement values 7-1 to 7-n enables the computing unit 9-1 to determine to which of the predetermined positions 8-1 - 8-n the measurement values 5 correspond and to issue this as the current position 10.

During the comparison of the measurement values 5 with the reference measurement values 7-1 to 7-n, the computing unit 9-1 can use predetermined intervals around the reference measurement values 7-1 to 7-n. If a measurement value 5 lies within the predetermined interval for the respective reference measurement value 7-1 to 7-n, it can be considered to be coincident. The predetermined intervals can for example be given as a percentage or absolute deviation from the reference measurement value 7-1 to 7-n.

In one embodiment, the sensor 4 can be designed as an acceleration sensor and/or a rotational speed sensor. This enables the detection of a variable that is directly dependent upon the movement of the sensor device 1-1 or a vehicle 2 (see FIG. 2) on which the sensor device 1-1 is arranged. For example, a curve with a predetermined radius and, for example, traversed by a subway train with a predetermined speed, generates a characteristic lateral acceleration and a characteristic rotational speed, which are dependent upon the radius of the curve and the speed of the subway train.

To enable different speeds of the vehicle 2 to be balanced out, in one embodiment, the sensor device 1-1 or the computing unit 9-1 can receive information from the vehicle relating to the current speed of the vehicle 2. This enables the computing unit 9-1, based on the current speed, to standardize the measurement values 5 or to adapt the reference measurement values 7-1 to 7-n to the current speed.

Although FIG. 1 only depicts one sensor 4, depending upon the application, it is also possible for a plurality of sensors to be used. For example, in one embodiment, additionally to acceleration sensors and/or rotational speed sensors, it is also possible for magnetic field sensors, pressure sensors, satellite-based position sensors, real-time clocks or any other suitable type of sensor to be used.

Magnetic field sensors can, for example, be used as a compass and detect an orientation of the vehicle 2. In the case of intersecting subway lines, this, can, for example, enable the subway line on which the vehicle 2 is moving to be identified from the orientation of the vehicle 2. Moreover, a pressure sensor can, for example, be used to determine a height of the vehicle 2.

Satellite-based position sensors can, for example, be used for the approximate detection of the position of the vehicle 2. The imprecisely detected position can be used to restrict the possible candidates for the current position 10 in the data storage unit 6 and the computing unit only has to compare the current measurement values 5 with a restricted data set. This speeds up the calculation of the current position. It is, for example, possible to specify a radius around the imprecisely detected position. Then, the comparison will only use the reference measurement values 7-1 to 7-n that relate to positions lying within the predetermined radius around the imprecisely detected position 1.

Behind the table, which is held resident in the data storage unit 6, dashed lines indicate a further table. This is intended to elucidate that, in one embodiment, the data storage unit 6 can comprise reference measurement values 8-1 to 8-n for a plurality of routes 3. In one such embodiment, the computing unit 9-1 can compare the measurement values 5 with the reference measurement values 8-1 to 8-n for the different routes 3 and in this way establish the route 3 on which the vehicle 2 is moving.

Where this patent application refers to the measurement values 5, this does not necessarily only indicate the current measurement values 5. Instead, this may simultaneously indicate a temporal change to the measurement values 5 or a historical consideration of the measurement values 5. The computing unit 9-1 can, for example, also perform a temporal derivation or integration of the measurement values 5 or a transformation of the measurement values 5 into the frequency range or the like. The reference measurement values 8-1 to 8-n can be stored in a corresponding form.

FIG. 2 depicts a vehicle 2 embodied as a train 2 comprising an embodiment of a sensor device according to the invention 1-2. For purposes of clarity and to avoid repetitions, FIG. 2 only depicts the components of the sensor device 1-2 that were not explained in detail with reference to FIG. 1.

The sensor device 1-2 in FIG. 2 comprises three wireless communication interfaces 12-1 to 12-3 that are used to issue the current position 10 of the train 2 wirelessly. This information can, for example, be detected by a smartphone of an occupant of the train 2 and displayed to the occupant. In one embodiment, it is also possible for only one of the wireless communication interfaces 12-1 to 12-3 to be provided.

f three wireless communication interfaces 12-1 to 12-3 or more wireless communication interfaces are provided, the current position 10 can, for example, be communicated to smartphones using the iBeacon standard. In one such embodiment, the wireless communication interfaces 12-1 to 12-3 are designed as Bluetooth interfaces 12-1 to 12-3.

The iBeacon standard provides that a predetermined unique identification is issued via each of the wireless communication interfaces 12-1 to 12-3. This is the same for each of the wireless communication interfaces 12-1 to 12-3 and identifies, for example, the provider of the transport service or the like.

In order to differentiate the individual current positions 10, it is moreover possible for a unique primary identifier and a unique secondary identifier to be predetermined for each of the predetermined positions 8-1 to 8-n.

If the computing unit 9-2 identifies one of the predetermined positions 8-1 to 8-n from the comparison of the measurement values 5 with the reference measurement values 7-1 to 7-n, the computing unit 9-2 issues the corresponding unique identification together with the corresponding unique primary identifier and the corresponding unique secondary identifier via the at least three wireless communication interfaces 12-1 to 12-3.

This makes it possible, for example, for a smartphone equipped with a suitable application to determine the current position 10 using the corresponding unique identification, the corresponding unique primary identifier and the corresponding unique secondary identifier, for example from a database.

Moreover, the sensor device 1-2 in FIG. 2 comprises a reference sensor 11, which, for example, can be an automatically or manually calibrated GPS sensor 11. Such sensors can, for example, with the aid of special auxiliary transmitters installed locally in the environment of the GPS sensor 11, achieve a precision of a few centimeters.

The control unit 9-2 can, for example, be switched to a detection mode. In this mode, the vehicle 2 can carry out a reference journey on a predetermined route 3. However, instead of using the measurement values 5 of the sensors 4 for comparison with the reference measurement values 7-1 to 7-n of the data storage unit 6, the control unit 9-2 can store the measurement values 5 issued by the sensors 4 in the data storage unit 6 as reference measurement values 7-1 to 7-n together with the current position 10 in each case, which can be detected by the GPS sensor 11. This enables the sensor device 1-2 also to be used to identify the current position 10 of a vehicle 2 on a route 3 that is not yet held resident in the data storage unit 6.

The method depicted in FIG. 3 can be used to determine the current position 10 of a vehicle 2.

To this end, measurement values 5 can be used to detect a movement of the vehicle 2 and/or physical variables of an environment of the vehicle 2, S1. Then, the detected measurement values 5 are compared with stored reference measurement values 7-1 to 7-n for which in each case a predetermined position 8-1 to 8-n is stored, S2. If the detected measurement values 5 coincide with the reference measurement values 7-1 to 7-n, the position 8-1 to 8-n corresponding to the respective reference measurement values 7-1 to 7-n is issued as the current position 10 of the vehicle 2, S3.

If measurement values 5 are detected during the method, these can comprise an acceleration, a rotational speed or the like of the vehicle 2. It is also possible for a movement of the vehicle, for example, to be calculated from these measurement values 5. Moreover, it is also possible for magnetic fields, pressure, satellite-based position data, a clock time or the like to be detected.

In one embodiment, the current position 10 can be issued via a wireless communication interface 12-1 to 12-3. This enables the simple transmission of the current position 10, for example, to smartphones, tablet PCs or notebooks of the occupants of the vehicle 2. To this end, in one embodiment, the wireless communication interface 12-1 to 12-3 can, for example, be designed as a Bluetooth interface, a WLAN interface, a GSM interface or the like.

In order to be able to use the method for a plurality of different routes, reference measurement values 7-1 to 7-n can be stored for a plurality of predetermined routes 3. It is then possible, based on the detected measurement values 5, to determine on which of the predetermined routes 3 the vehicle 2 is moving.

In order to enable the present method also to be used on routes 3 for which no reference measurement values 7-1 to 7-n are held resident, a reference journey of the vehicle 2 can be provided with which, for a predetermined route 3, the measurement values 5 are stored in the data storage unit 6 as the reference measurement values 7-1 to 7-n together with the respective current position 10 of the vehicle 2.

In order to increase the precision of the reference measurement values 7-1 to 7-n obtained with a measuring journey of this kind, the respective current position 10 can be requested from a reference sensor 11, for example a user-calibrated satellite-based sensor 11.

FIG. 4 shows a route 3 on which predetermined positions 8-2-8-6 are in each case marked by a star. The route 3 can, for example, be the route 3 of a subway line.

FIG. 4 shows by way of example only the five positions 8-2 to 8-6. In further embodiments, the number of positions 8-2 to 8-6 can depend on the length of the route 3 and the desired spatial resolution. If, for example, a maximum spatial resolution of five meters is desired, corresponding positions 8-2 to 8-6 can be provided every five meters along the route 3.

Moreover, in one embodiment, the computing unit 9-1, 9-2 can be designed to interpolate the reference measurement values 7-1 to 7-n between two positions 8-1 to 8-n. This enables the spatial resolution to be increased without having to hold resident further reference measurement values 7-1 to 7-n in the data storage unit 6.

If, for example, a subway train is traveling in the clockwise direction on the route 3 and starts the journey between positions 8-2 and 8-3, the curve on which position 8-3 is located is, for example, characterized in the reference measurement values 7-3 by characteristic acceleration value and rotational speeds, which, when traveling through this curve, are reproduced by the sensors 4 or the measurement values 5. The same applies to all further positions 8-2-8-6. Herein, the greater the number of simultaneously used measurement values 5, the greater the probability of the measurement values 5 being sufficiently different to identify different positions.

In one embodiment, the reference measurement values 7-1 to 7-n can, for example, also comprise SSIDs and corresponding signal strengths for WLAN networks or the like. Vibration sensors can, for example, also detect characteristic vibrations, which, are for example induced in a specific section of the route 3.

In one embodiment, the detection of the clock time also enables specific routes 3 to be excluded since, for example, no vehicle is traveling on the corresponding route 3 or corresponding positions 8-1 to 8-n of the respective route at the respective clock time.

Finally, reference is made once again to the fact that the sensor devices, vehicles, uses and methods described in detail above are only exemplary embodiments that can be modified by the person skilled in the art in a wide variety of ways without departing from the scope of the invention. Furthermore, the use of the indefinite article “a” or “an” does not preclude the possibility that the features in question may also be present on a multiple basis. Similarly, the possibility is not precluded that elements of the present invention depicted as individual units can comprise a plurality of interacting components, which could also be spatially distributed.

1-15. (canceled)

16. A sensor device for a vehicle or rail vehicle traveling on a predetermined route, the sensor device comprising:
a plurality of sensors configured to detect at least one of a movement of the sensor device or physical variables of an environment of the sensor device and to issue corresponding measurement values, said sensors including magnetic field sensors for detecting an orientation of the vehicle;
a data storage unit configured to store reference measurement values for said sensors relating to predetermined positions on the predetermined route; and
a computing unit configured:
to compare the measurement values, including measurement values detected for detection of an orientation of the vehicle, issued by said sensors with the stored reference measurement values and
to issue a position corresponding to the respective reference measurement values as a current position of the sensor device, when the measurement values issued by said sensors coincide with the reference measurement values.

17. The sensor device according to claim 16, which further comprises a wireless communication interface, said computing unit being configured to issue the current position of the sensor device through said wireless communication interface.

18. The sensor device according to claim 17, wherein said wireless communication interface is at least one of a Bluetooth interface or a WLAN interface or a GSM interface.

19. The sensor device according to claim 16, wherein said sensors include at least one of acceleration sensors or rotational speed sensors.

20. The sensor device according to claim 19, wherein said computing unit is configured to calculate a movement of the sensor device based on the measurement values issued by at least one of said acceleration sensors or rotational speed sensors.

21. The sensor device according to claim 16, wherein said sensors further include satellite-based position sensors.

22. The sensor device according to claim 16, wherein said data storage unit includes reference measurement values for a plurality of predetermined routes, and said computing unit is configured to determine on which of the predetermined routes the vehicle is moving based on the measurement values issued by said sensors.

23. The sensor device according to claim 16, which further comprises at least three wireless communication interfaces, said computing unit being configured to issue a predetermined unique identification and a unique primary identifier and a unique secondary identifier for each current position through each of said wireless communication interfaces.

24. The sensor device according to claim 23, wherein said at least three wireless communication interfaces are Bluetooth interfaces.

25. The sensor device according to claim 16, wherein said computing unit is configured to store in said data storage unit the measurement values issued by said sensors during a reference journey on the predetermined route of the vehicle on which the sensor device is disposed as the reference measurement values together with the respective current position of the sensor device.

26. The sensor device according to claim 25, wherein said computing unit is configured to request the respective current position from a reference sensor.

27. The sensor device according to claim 26, wherein said reference sensor is a user-calibrated satellite-based sensor.

28. A vehicle or rail vehicle, comprising a sensor device according to claim 16.

29. A method for determining a position of a vehicle or rail vehicle traveling on a predetermined route, the method comprising the following steps:
providing a sensor device including:
a plurality of sensors configured to detect at least one of a movement of the sensor device or physical variables of an environment of the sensor device and to issue corresponding measurement values, the sensors including magnetic field sensors for detecting an orientation of the vehicle;
a data storage unit configured to store reference measurement values for the sensors relating to predetermined positions on the predetermined route; and
a computing unit configured:
to compare the measurement values, including measurement values detected for detection of an orientation of the vehicle, issued by the sensors with the stored reference measurement values and
to issue a position corresponding to the respective reference measurement values as a current position of the sensor device, when the measurement values issued by the sensors coincide with the reference measurement values; and
using the sensor device for determining the position of the vehicle or rail vehicle.

30. A method for detecting a position of a vehicle or rail vehicle traveling on a predetermined route, the method comprising the following steps:
detecting measurement values of at least one of a movement of the vehicle or physical variables of an environment of the vehicle, the detection of the measurement values including a detection of an orientation of the vehicle based on magnetic fields;
comparing the detected measurement values including the measurement values detected for determination of the orientation of the vehicle, with stored reference measurement values for each of which a respective position is stored; and issuing the position corresponding to the respective reference measurement values as a current position of the vehicle when the detected measurement values coincide with the reference measurement values.

31. The method according to claim 30, which further comprises issuing the current position through a wireless communication interface.

32. The method according to claim 31, which further comprises providing at least one of a Bluetooth interface or a WLAN interface or a GSM interface as the wireless communication interface.

33. The method according to claim 30, which further comprises carrying out the step of detecting the measurement values by:
detecting at least one of at least one acceleration or at least one rotational speed of the vehicle; or
detecting satellite-based position data.

34. The method according to claim 33, which further comprises calculating a movement of the vehicle based on the detected at least one of at least one acceleration or at least one rotational speed.

35. The method according to claim 33, which further comprises at least one of:
storing the reference measurement values for a plurality of predetermined routes and using the detected measurement values as a basis for determining on which of the predetermined routes the vehicle is moving; or
during a reference journey of the vehicle on a predetermined route, storing the measurement values in the data storage unit as the reference measurement values together with the respective current position of the vehicle, and requesting the respective current position.

36. The method according to claim 35, which further comprises requesting the respective current position from a reference sensor or a user-calibrated satellite-based sensor.
